(19) United States
(12) Patent Application Publication
(10) Pub. No.: US 2016/0143473 A1
(43) Pub. Date: May 26, 2016

(54) DEVICE FOR COOKING AND COOLING BOILED EGGS

(71) Applicant: Enhanced Product Development, Inc., Minneapolis, MN (US)

(72) Inventors: Glen Allen Yarbrough, Nashville, TN (US); Trevor John Lambert, Brooklyn Park, MN (US)

(21) Appl. No.: 14/947,069

(22) Filed: Nov. 20, 2015

Related U.S. Application Data
(60) Provisional application No. 62/123,577, filed on Nov. 20, 2014.

(51) Int. Cl. A47J 29/06; A47J 27/10

(52) U.S. Cl. CPC A47J 29/06; A47J 27/10

(57) ABSTRACT

Described herein is a device to hold eggs during the cooking and cooling process for the creation of boiled eggs. The egg cooking device includes a frame capable of holding at least one egg while in boiling water and a handle that may be used to lift the device in and out of boiling water and a spout assembly for distributing cold water over the egg holders to cool them simultaneously.

### PRIORITY CLAIM

The present nonprovisional patent application claims the benefit of and priority to, under 35 USC §119(e), U.S. Provisional Patent Application No. 62/123,577, filed Nov. 20, 2014, entitled “DEVICE FOR COOKING AND COOLING BOILED EGGS”, the entirety of which is incorporated herein by reference.

### FIELD AND BACKGROUND OF THE INVENTION

The invention relates generally to a device to hold eggs during the cooking and cooling process for the creation of boiled eggs.

Currently there are a number of solutions for creating boiled eggs. Some of these solutions attempt to place eggs in a pan of boiling water, but these solutions fail to meet the needs of the market because if the water is at a rolling boil, the eggs can become cracked when hitting the bottom or sides of the pan. Other solutions attempt to cook eggs by other methods such as frying, but these solutions are similarly unable to meet the needs of the market because frying adds extra calories and fat with the use of oil in cooking fried eggs. Still other solutions seek to stick with the traditional boiled method, but these solutions also fail to meet market needs because some people are never sure how long to boil an egg and end up with undercooked or overcooked eggs.

### SUMMARY OF THE INVENTION

It would be advantageous to have an apparatus that allows a user to store, boil and peel eggs in extremely convenient manner. Furthermore, it would also be advantageous to have an apparatus that holds a large number of eggs which is then lowered into boiling water all at the same time for regulated cooking of all of the eggs. Still further, it would be advantageous to have an apparatus that lifts all of the eggs out of the boiling water in a quickly and easily. Therefore, there currently exists a need in the market for an apparatus that holds eggs during the boiling process, has a timer to alert the user when to remove the eggs from the boiling water, and holds the eggs under cool water with the assistance of a funnel feature to cool down all of the eggs quickly so the eggs can be peeled.

The invention advantageously fills the aforementioned deficiencies by providing a device to hold eggs during the cooking and cooling process for the creation of boiled eggs, which provides a timer to alert the user to the proper length of time to cook. The timer may be made from a color-changing color, wherein the timer changes color after a predetermined amount of time in the presence of hot water.

In one example embodiment, the invention is a cooking device that securely holds each egg during the boiling process, making sure none of the eggs become cracked due to contact during the cooking process. The frame device holds the eggs still during the cooking process and also allows the user to store the eggs in the refrigerator while still in the device.

In one example embodiment, the apparatus' handle serves as a funnel that directs the water into a dispenser hub that directs cool water over each egg simultaneously. The egg holding frames are designed to hold each egg securely while directing the water over each egg.

In one example embodiment, the cooking apparatus may also include an egg cooking timer. In a related example embodiment, the timer is made from a color changing material; the timer's color changes to alert the user to what cooked stage the egg is cooked to: soft boiled, hard boiled etc. When the user starts the cooling process the timer returns to its original, non-heated color, which may indicate that the eggs are ready to peel.

The apparatus may also include a funnel/handle that retracts (similar to telescopic structure) into the hub to allow for easy storage. Still further, the apparatus can be built with or without a second layer of egg holders on the bottom level which is intended for the purpose of doubling the capacity of eggs. It also can be made with or without the timer. In a related embodiment, each of the egg holders is detachable in case you want to cook fewer eggs.

In an embodiment, the device for boiling eggs includes a frame and a handle, wherein the device is capable of being submerged in water. The frame has a plurality of egg holders, each egg holder is capable of holding an egg in a stationary position. The handle is operatively connected to a portion of the frame and extends up from the portion of the frame. The handle may be operatively connected to a center or a portion of the frame. Still further, the handle may be capable of being disconnected from the frame. The frame is capable of holding one or more eggs; for example, up to eight eggs. A second frame may be added (in an attachable fashion) to the device to hold an additional one to eight eggs. The second frame may be located below the first frame and is connected to a portion or center of the first frame. The first frame and second frame may be capable of being separated for storage.

The device may further include egg holders having a plurality of holes or apertures that allow water to drain through the egg holders. The device may also include a set of legs that support the device. In a related embodiment, the egg holders are interchangeable with smaller or large holders to accommodate eggs of different sizes, such as duck eggs.

In another embodiment, a device may include a dispenser hub above the frame, the dispenser hub comprises a spout assembly located above the egg holders and is capable of directing water flow over the egg holders. In an embodiment, there may be the same number of egg holders and spouts extending from the spout assembly. In yet another embodiment, the handle is a funnel capable of directing water into the dispenser hub to direct water over the egg holders. For example, the funnel may direct water into the dispenser hub, through the spout assembly, and over the egg holders. The handle may be made from an insulated material. Such an insulated material may enable a user to pick up the device, or to allow the water that is dispensed through handle to stay cold. In yet another embodiment, the frame is made from microwaveable or oven-safe material to allow for a brief warming period when taking the frame and cooked eggs from the refrigerator. The frame can also be used for egg decorating as the egg holders can keep the eggs upright.

The invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 illustrates a side view of an example embodiment of an egg boiling device;

FIG. 2 illustrates a bottom view of the egg boiling device of FIG. 1;

FIG. 3 illustrates an example embodiment of an egg boiling device with a timer;

FIG. 4 illustrates another view of an egg boiling device;

FIG. 5 illustrates a view of the egg cooking device in a collapsed configuration;

FIG. 6 illustrates an alternative embodiment of an egg boiling device; and

FIG. 7 illustrates a top view of the egg boiling device.

### DETAILED DESCRIPTION OF THE INVENTION

Following are more detailed descriptions of various related concepts related to, and embodiments of, methods and apparatus according to the present disclosure. It should be appreciated that various aspects of the subject matter introduced above and discussed in greater detail below may be implemented in any of numerous ways, as the subject matter is not limited to any particular manner of implementation. Examples of specific implementations and applications are provided primarily for illustrative purposes.

The invention is directed to be a device to hold eggs during the cooking and cooling process for the creation of boiled eggs. The invention is a device that allows a user to store, boil and peel eggs in extremely convenient manner. The user gently lowers the device holding eggs into boiling water. Eggs are held securely during cooking, which mitigates shell fracture. The device cools the eggs with a funnel function of the handle that diverts the flow of cool water from a kitchen faucet over each egg simultaneously allowing very easy shell removal from the cooled eggs. A timer on the device allows the user to determine precise cooking time and will determine the exact level of hardness of yoke as desired. The handy frame design of this device will allow the user to store the eggs in the refrigerator until ready to eat if so desired.

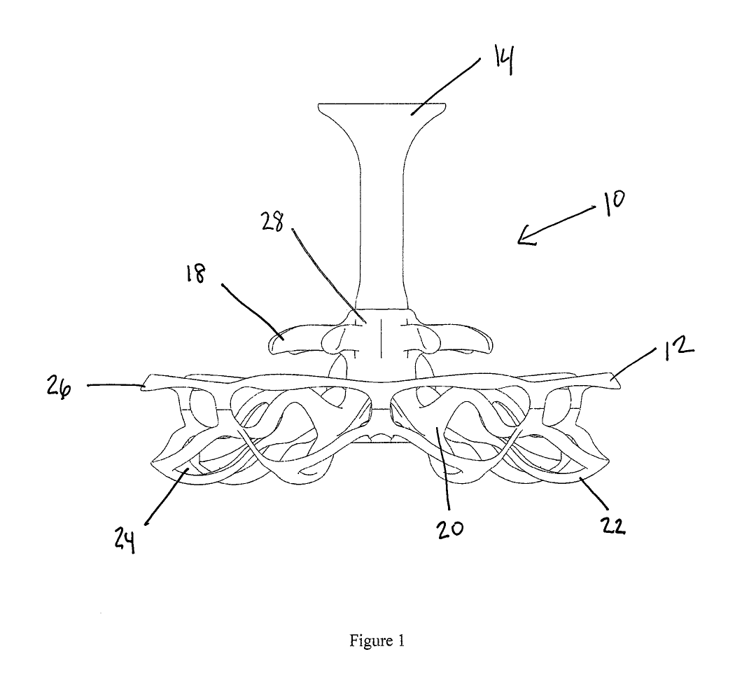

Referring to the figures, FIG. 1 illustrates a side view of an egg cooking device 10 with a handle 14 in an upright position. Egg cooking device 10 includes a frame 12 having one or more egg holders 20. Egg holders 20 may be arranged around the perimeter of handle 14 in a generally cylindrical orientation, but it is not necessary limited to this orientation and arrangement. Egg holders 20 are shaped to hold an egg in a stationary position and may include slits or slots 24 at egg holder base 22, egg holder sides 26, or both.

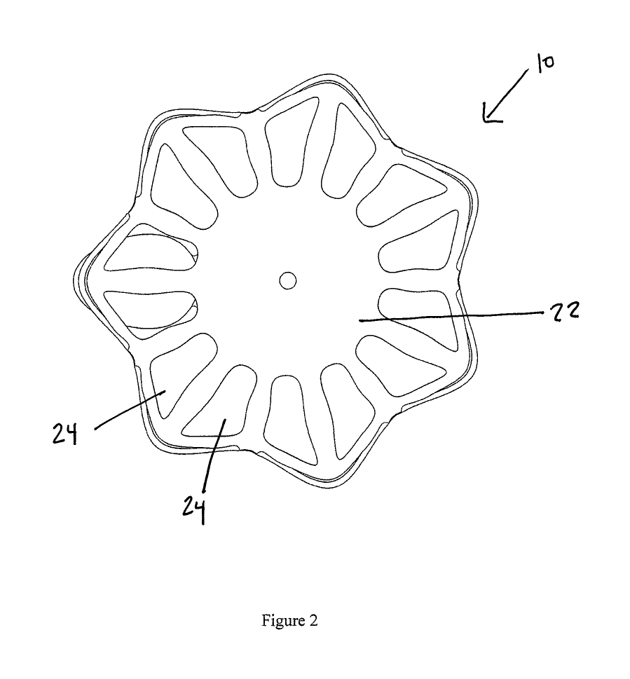

FIG. 2 illustrates the bottom of the egg cooking device 10 highlighting the frame 12 and egg holder base 22. Egg holder base 22 includes one or more slits or slots 24 in each egg holder 20. Slit or slot 24 may be any size or shape that allows water to pass through egg holder 20, while still supporting an egg. Slits or slots 24 allow water to drain through the egg holders 20, while holding the eggs in a stationary position. In an alternative embodiment, egg holder base 22 may be solid.

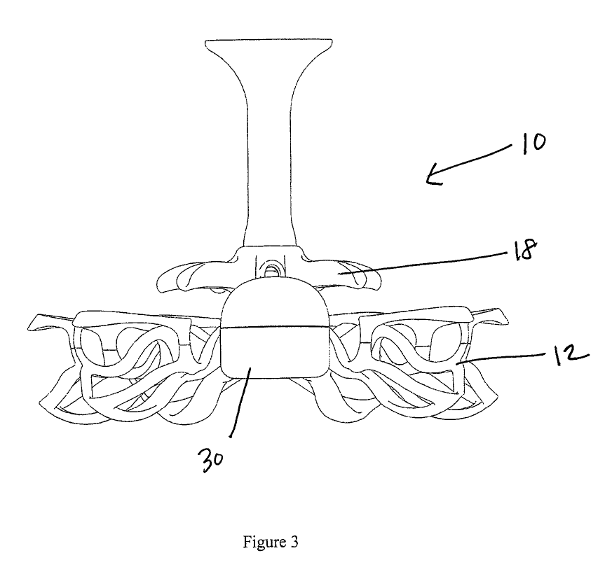

FIG. 3 illustrates the front of the egg cooking device 10 highlighting a timing device 30. Timing device 30 may be located on frame 12, as shown. Alternatively, timing device 30 may be located below frame 12, under handle 14, or under a spout 18. Timing device 30 may be integral to egg cooking device 10, or may be removable. Timing device 30 may be made from a material that is capable of changing color after a predetermined amount of time in the presence of hot water. Alternatively, timing device 30 may alert the user by other means that a predetermined amount of time has passed.

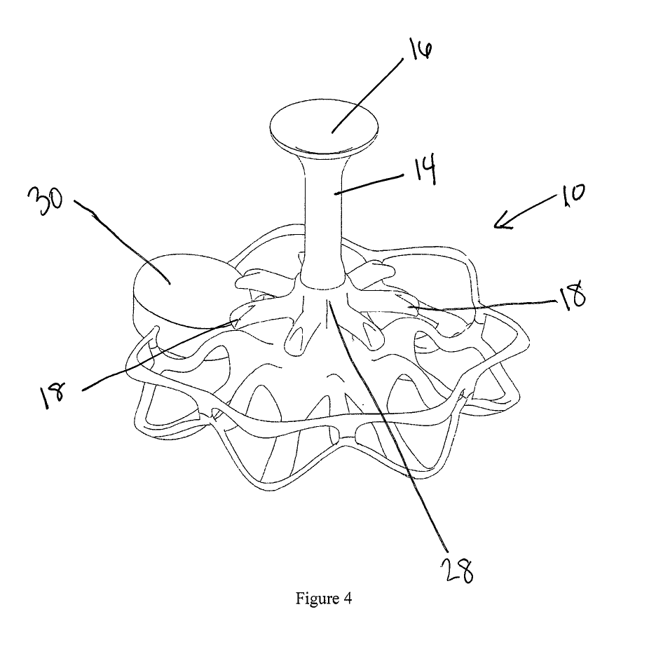

FIG. 4 illustrates an isolated view of the egg cooking device 10 illustrating the dispenser hub 28. Dispenser hub 28 comprises a spout assembly 18, wherein the spout assembly 18 is located above the egg holder 20. Dispenser hub 28 is in fluid communication with funnel 16 at one end and spout assembly 18 at an opposing end. In use, water is introduced through funnel 16, which flows through dispenser hub 28, and out through spout assembly 18 over egg holder 20. Cold water can be poured through funnel 16 to cool the eggs after being removed from boiling water. In a related embodiment, the spout assembly is a circumferential pan or plate that is in contact with funnel and/or hub to dispense water over all of the egg holders simultaneously.

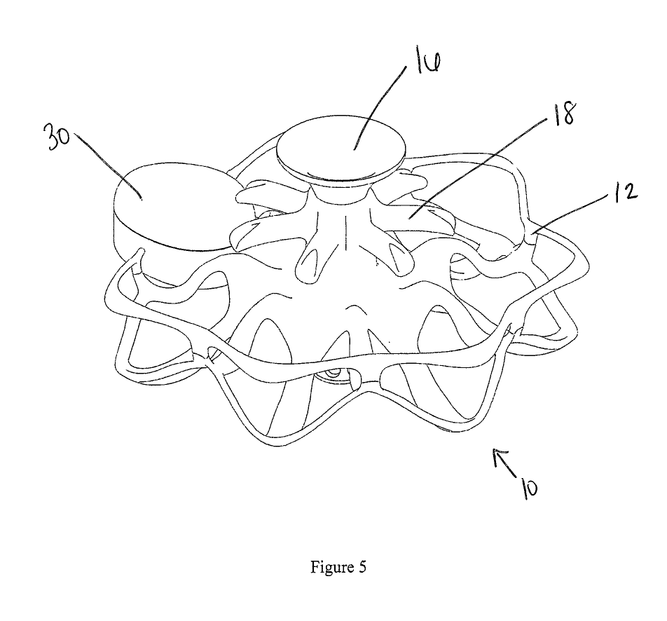

FIG. 5 illustrates an isolated view of the device with the handle/funnel in a collapsed position for easy storage. In an embodiment, handle 14 may compress toward frame 12 to reduce the overall height of the device 10. In an alternative embodiment, the handle 14 may be removed from the frame 12. The individual egg holders can also be added or removed as needed.

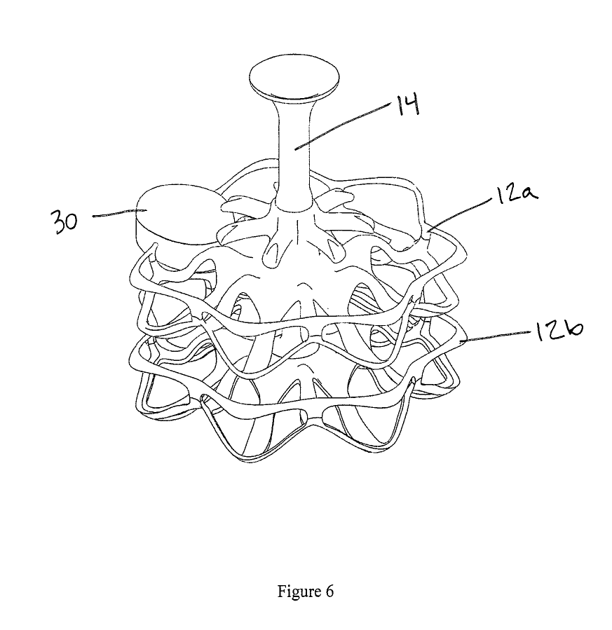

FIG. 6 illustrates an example embodiment of the device 10 comprising two frames 12. A first frame 12a is located above a second frame 12b. Handle 14 may extend through the first frame 12a to the second frame 12b. In an alternative embodiment, the funnel 16 is in fluid communication with both the dispenser hub 28 and spout assembly 18, which can dispense water over both the first frame 12a and the second frame 12b. In an alternative embodiment, second frame 12b may include a second dispenser hub (not shown) and associated spout assembly (not shown). Funnel 16 may be in fluid communication with both first frame 12a dispenser hub 28 and second frame 12b dispensing hub (not shown).

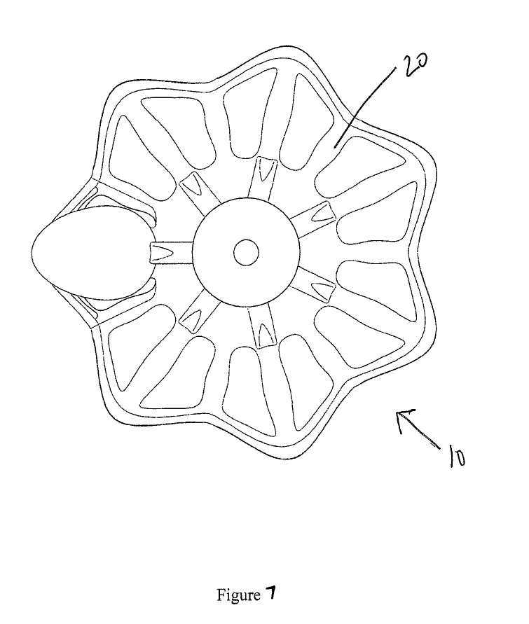

FIG. 7 illustrates a top view of the egg cooking device 10. Egg holders 20 may hold eggs in an upright position or in a lateral position.

The following patents are incorporated by reference in their entireties: U.S. Pat. Nos. 2,039,477; 5,934,185; and 8,245,632.

While the invention has been described above in terms of specific embodiments, it is to be understood that the invention is not limited to these disclosed embodiments. Upon reading the teachings of this disclosure many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed is:

1. A device for cooking eggs comprising
a frame having a plurality of egg holders, each egg holder capable of holding an egg in a stationary position, and
a handle operatively connected to a portion of the frame and extending up from the portion of the frame, the handle including a dispenser hub located above the frame with at least one spout assembly located above the egg holders and capable of directing water flow over the egg holders, wherein the device is capable of submerging one or more eggs in water.

2. The device of claim 1, wherein the frame is capable of holding one or more eggs.

3. The device of claim 1, wherein the egg holders include a plurality of holes or apertures that allow water to drain through the egg holders.

4. The device of claim 1 comprising a second frame having a plurality of egg holders capable of holding one or more eggs in a stationary position, wherein the second frame is located below the first frame and is connected at a portion of the first frame.

5. The device of claim 1 wherein the spout assembly includes at least one spout located above each egg holder and capable of directing water flow from the dispenser hub over the egg holder.

6. The device of claim 1, wherein the spout assembly comprises a circumferential member coupled to an end of the dispenser hub adjacent each of the egg holders and is adapted to direct fluid over all of the egg holders simultaneously.

7. The device of claim 1, wherein the handle is a funnel, the funnel capable of directing water into the dispenser hub that directs water over one or more of the egg holders.

8. The device of claim 1, wherein a bottom of the frame includes a set of legs that support the device.

9. The device of claim 1 further comprising a timer.

10. The device of claim 9, wherein the timer is a color-changing device that is capable of changing color after a predetermined amount of time in the presence of hot water.

11. The device of claim 1, wherein the handle is operatively connected to a center of the frame.

12. The device of claim 1, wherein the frame is configurable to hold one to eight eggs.

13. The device of claim 1 capable of collapsing telescopically for storage, wherein the handle is separable from the frame.

14. The device of claim 1, wherein the handle is insulated.

15. A device for boiling eggs, the device comprising
a frame having a plurality of egg holders, each egg holder capable of holding an egg in a stationary position,
a handle operatively connected to a portion of the frame and extending up from the portion of the frame,
a dispenser hub located above the frame, the dispenser hub comprising at least one spout assembly located above the egg holders and capable of directing a water flow over the egg holder; and
a timer, and wherein the device is capable of submerging one or more eggs in water.

16. A device for boiling eggs comprising
a frame having a plurality of egg holders, each egg holder capable of holding an egg in a stationary position,
a handle operatively connected to a portion of the frame and extending up from the portion of the frame, and
a dispenser hub located above the frame located above the frame, the dispenser hub comprising at least one spout assembly located above the egg holders and capable of directing a water flow over the egg holder

17. The device of claim 16, wherein the spout assembly comprises a circumferential member coupled to an end of the dispenser hub adjacent each of the egg holders and is adapted to direct fluid over all of the egg holders simultaneously.

18. The device of claim 16, further comprising a timer.

19. The device of claim 18, wherein the timer is a color-changing device that is capable of changing color after a predetermined amount of time in the presence of hot water.

20. The device of claim 16, wherein the frame is configurable to hold one to eight eggs.
